(19) United States
(12) Patent Application Publication
(10) Pub. No.: US 2023/0337327 A1
(43) Pub. Date: Oct. 19, 2023

(54) COMMUNICATION CONTROL METHOD AND USER EQUIPMENT

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/339,896

(22) Filed: Jun. 22, 2023

Related U.S. Application Data
(63) Continuation of application No. PCT/JP2021/046549, filed on Dec. 16, 2021.

(30) Foreign Application Priority Data
Dec. 23, 2020 (JP) 2020-214243

(51) Int. Cl. H04W 76/40

(52) U.S. Cl. CPC H04W 76/40

(57) ABSTRACT

A communication control method performed by a UE in a mobile communication system for providing a multicast broadcast service (MBS) includes step S105 of receiving MBS data transmitted from a gNB through a transmission scheme either of Point-To-Point (PTP) transmission or Point-To-Multipoint (PTM) transmission, step S107 of triggering transmission of a status report indicating a reception status of the MBS data in a predetermined layer of the UE in response to switching of the transmission scheme between the PTP transmission and the PTM transmission, and step S108 of transmitting the status report to the gNB.

### RELATED APPLICATIONS

The present application is a continuation based on PCT Application No. PCT/JP2021/046549, filed on Dec. 16, 2021, which claims the benefit of Japanese Patent Application No. 2020-214243 filed on Dec. 23, 2020. The content of which is incorporated by reference herein in their entirety.

### TECHNICAL FIELD

The present disclosure relates to a communication control method and a user equipment used in a mobile communication system.

### BACKGROUND OF INVENTION

In recent years, a mobile communication system of the fifth generation (5G) has attracted attention. New Radio (NR), which is a Radio Access Technology (RAT) of the 5G System, has features such as high speed, large capacity, high reliability, and low latency compared to Long Term Evolution (LTE), which is a fourth generation radio access technology.

### CITATION LIST

### Non-Patent Literature

Non-Patent Document 1: 3GPP Technical Specification “3GPP TS 38.300 V16.3.0 (2020-09)”

### SUMMARY

A communication control method according to a first aspect is a communication control method performed by a user equipment in a mobile communication system for providing a multicast broadcast service (MBS). The communication control method includes receiving MBS data transmitted from a base station in a transmission scheme either of Point-To-Point (PTP) transmission or Point-To-Multipoint (PTM) transmission, triggering transmission of a status report indicating a reception status of the MBS data in a predetermined layer of a user equipment in response to switching of the transmission scheme between the PTP transmission and the PTM transmission, and transmitting the status report to the base station.

A user equipment according to a second aspect is a user equipment used in a mobile communication system for providing a multicast broadcast service (MBS). The user equipment includes a receiver configured to receive MBS data transmitted from a base station in a transmission scheme either of Point-To-Point (PTP) transmission or Point-To-Multipoint (PTM) transmission, a controller configured to trigger transmission of a status report indicating a reception status of the MBS data in a predetermined layer of the user equipment in response to switching of the transmission scheme between the PTP transmission and the PTM transmission, and a transmitter configured to transmit the status report to the base station.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a correspondence relationship between a downlink Logical channel and a downlink Transport channel according to an embodiment.

FIG. 7 is a diagram illustrating a delivery method of MBS data according to an embodiment.

FIG. 8 is a diagram illustrating a split MBS bearer according to an embodiment.

FIG. 9 is a diagram illustrating Operation Example 1 related to activation and deactivation of a leg according to an embodiment.

FIG. 10 is a diagram illustrating Operation Example 2 related to activation and deactivation of a leg according to an embodiment.

FIG. 11 is a diagram illustrating an example of a MAC CE (one octet) storing an indication value for each bearer identifier (or logical channel identifier) according to an embodiment.

FIG. 12 is a diagram illustrating a configuration example of a PDCP status report according to an embodiment.

FIG. 13 is a diagram illustrating an operation of switching from PTM transmission to PTP transmission according to an embodiment.

FIG. 14 is a diagram illustrating an operation of switching from PTP transmission to PTM transmission according to an embodiment.

FIG. 15 is a diagram illustrating a variation of an operation of switching from PTP transmission to PTM transmission according to an embodiment.

### DESCRIPTION OF EMBODIMENTS

Introduction of multicast broadcast services to the 5G system (NR) has been under study. NR multicast broadcast services are desired to provide enhanced services compared to LTE multicast broadcast services.

The present disclosure provides an improved multicast broadcast service.

A mobile communication system according to an embodiment is described with reference to the drawings. In the description of the drawings, the same or similar parts are denoted by the same or similar reference signs.

Configuration of Mobile Communication System

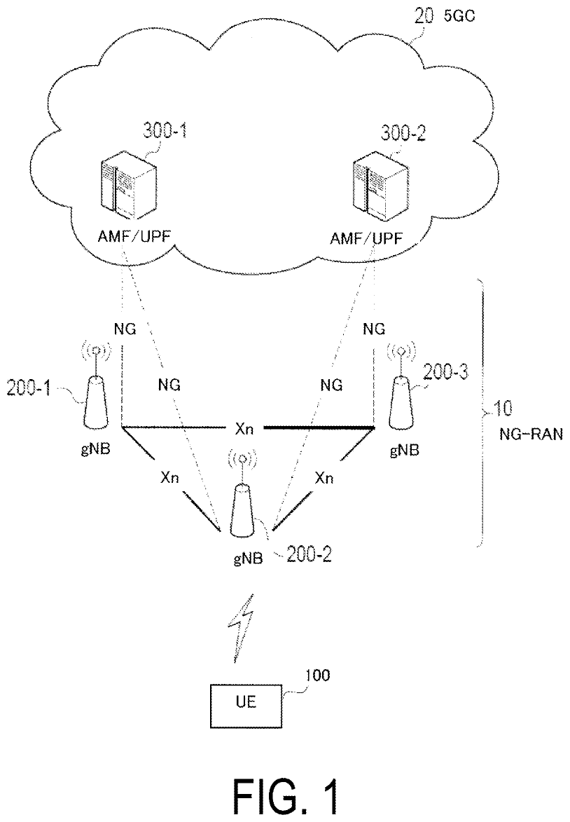

First, a configuration of a mobile communication system according to an embodiment is described. FIG. 1 is a diagram illustrating a configuration of the mobile communication system according to an embodiment. This mobile communication system complies with the 5th Generation System (5GS) of the 3GPP standard. The description below takes the 5GS as an example, but Long Term Evolution (LTE) system or the sixth generation (6G) system may be at least partially applied to the mobile communication system.

As illustrated in FIG. 1, the mobile communication system includes a user equipment (UE) 100, a 5G radio access network (next generation radio access network (NG-RAN)) 10, and a 5G core network (5GC) 20.

The UE 100 is a mobile wireless communication apparatus. The UE 100 may be any apparatus as long as the apparatus is utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or a plurality of cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

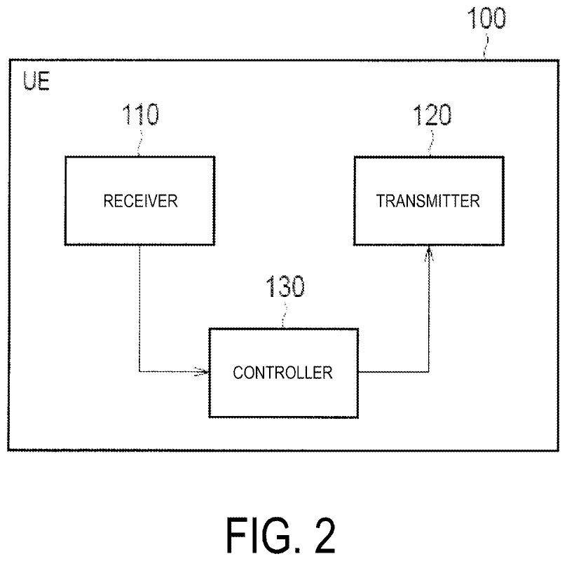

FIG. 2 is a diagram illustrating a configuration of the UE 100 (user equipment) according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal output by the controller 130 (a transmission signal) into a radio signal and transmits the resulting signal through the antenna.

The controller 130 performs various types of control in the UE 100. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

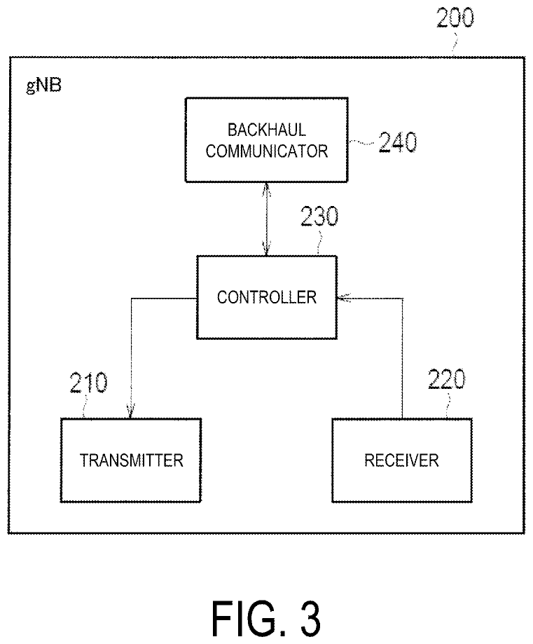

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

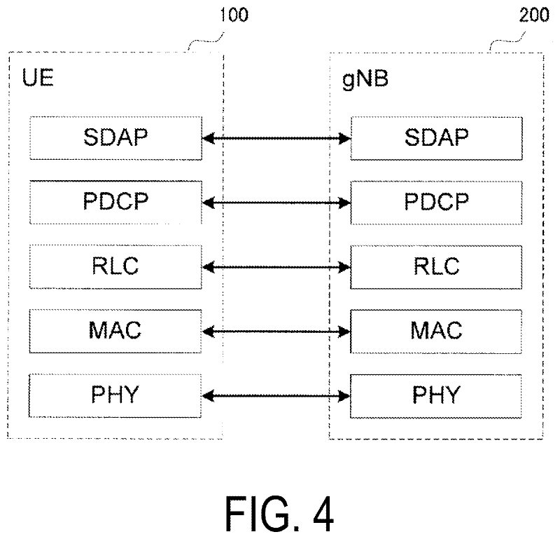

FIG. 4 is a diagram illustrating a configuration of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of QoS control by a core network and a radio bearer as the unit of QoS control by an access stratum (AS). Note that, when the RAN is connected to the EPC, the SDAP may not be provided.

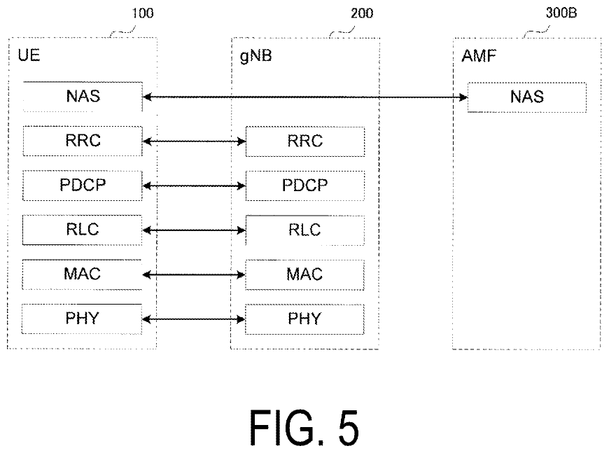

FIG. 5 is a diagram illustrating a configuration of a protocol stack of a radio interface of a control plane handling signaling (control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, reestablishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state.

When the connection between the RRC of the UE 100 and the RRC of the gNB 200 is suspended, the UE 100 is in an RRC inactive state.

The NAS layer which is higher than the RRC layer performs session management, mobility management, and the like. NAS signaling is transmitted between the NAS layer of the UE 100 and the NAS layer of the AMF 300B.

Note that the UE 100 includes an application layer other than the protocol of the radio interface.

MBS

The MBS according to an embodiment is described. The MBS is a service in which the NG-RAN 10 can provide broadcast or multicast, i.e., point-to-multipoint (PTM) data transmission to the UE 100. The MBS may be referred to as the Multimedia Broadcast and Multicast Service (MBMS). Note that use cases (service types) of the MBS include public communication, mission critical communication, V2X (Vehicle to Everything) communication, IPv4 or IPv6 multicast delivery, IPTV, group communication, and software delivery.

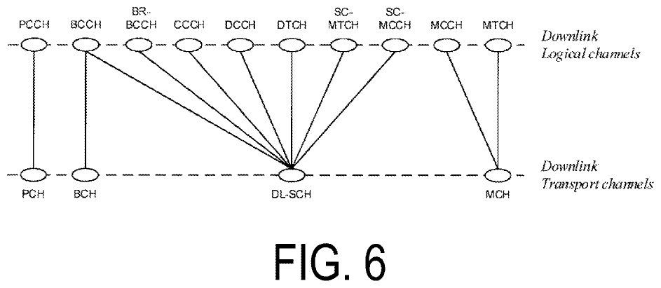

MBS Transmission in LTE includes two schemes, i.e., a Multicast Broadcast Single Frequency Network (MBSFN) transmission and Single Cell Point-To-Multipoint (SC-PTM) transmission. FIG. 6 is a diagram illustrating a correspondence relationship between a downlink Logical channel and a downlink Transport channel according to an embodiment.

As illustrated in FIG. 6, the logical channels used for MBSFN transmission are a Multicast Traffic Channel (MTCH) and a Multicast Control Channel (MCCH), and the transport channel used for MBSFN transmission is a Multicast Control Channel (MCH). The MBSFN transmission is designed primarily for multi-cell transmission, and in an MBSFN area including a plurality of cells, each cell synchronously transmits the same signal (the same data) in the same MBSFN subframe.

The logical channels used for SC-PTM transmission are a Single Cell Multicast Traffic Channel (SC-MTCH) and a Single Cell Multicast Control Channel (SC-MCCH). The transport channel used for SC-PTM transmission is a Downlink Shared Channel (DL-SCH). The SC-PTM transmission is primarily designed for single-cell transmission, and corresponds to broadcast or multicast data transmission on a cell-by-cell basis. The physical channels used for SC-PTM transmission are a Physical Downlink Control Channel (PDCCH) and a Physical Downlink Control Channel (PDSCH), and enables dynamic resource allocation.

Although an example will be mainly described below in which the MBS is provided using a scheme the same as, and/or similar to, the SC-PTM transmission scheme, the MBS may be provided using the MBSFN transmission scheme. An example will be mainly described in which the MBS is provided using multicast. Accordingly, the MBS may be interpreted as multicast. Note that, the MBS may be provided using broadcast.

MBS data refers to data provided by the MBS, an MBS control channel refers to the MCCH or SC-MCCH, and an MBS traffic channel refers to the MTCH or SC-MTCH. However, the MBS data may be transmitted through unicast. The MBS data may be referred to as MBS packets or MBS traffic.

The network can provide different MBS services for respective MBS sessions. The MBS session is identified by at least one of Temporary Mobile Group Identity (TMGI) and a session identifier, and at least one of these identifiers is referred to as an MBS session identifier. Such an MBS session identifier may be referred to as an MBS service identifier or a multicast group identifier.

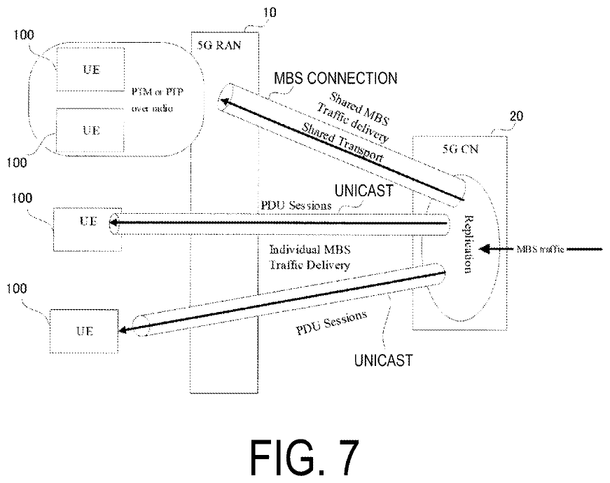

FIG. 7 is a diagram illustrating a delivery method of the MBS data according to an embodiment.

As illustrated in FIG. 7, the MBS data (MBS traffic) is delivered from a single data source (application service provider) to a plurality of UEs. The 5G CN (5G) 20, which is a 5GC core network, receives the MBS data from the application service provider and performs replication of the MBS data to deliver the resulting MBS data.

From the perspective of the 5GC 20, two delivery methods are possible: shared MBS data delivery (shared MBS traffic delivery) and individual MBS data delivery (individual MBS traffic delivery).

In the shared MBS data delivery, a connection is established between the NG-RAN 10 that is a 5G radio access network (5G RAN) and the 5GC 20 to deliver the MBS data from the 5GC 20 to the NG-RAN 10. Such a connection (a tunnel) is hereinafter referred to as an “MBS connection”.

The MBS connection may be referred to as a shared MBS traffic delivery connection or a shared transport. The MBS connection terminates at the NG-RAN 10 (i.e., the gNB 200). The MBS connection may correspond to an MBS session on a one to-one basis.

The gNB 200 selects a transmission scheme either of Point-to-Point (PTP: unicast) or Point-to-Multipoint (PTM: multicast or broadcast) at the discretion of the gNB 200, and transmits the MBS data to the UE 100 through the selected transmission scheme.

On the other hand, in the individual MBS data delivery, a unicast session is established between the NG-RAN 10 and the UE 100 to individually deliver the MBS data from the 5GC 20 to the UE 100. Such unicast may be referred to as a PDU session.

The unicast (PDU session) terminates at the UE 100.

Split MBS Bearer

The split MBS bearer according to an embodiment is described.

The gNB 200 may configure an MBS bearer split into a PTP communication path and a PTM communication path (hereinafter referred to as a “split MBS bearer” as appropriate) for the UE 100. This allows the gNB 200 to dynamically switch the transmission of the MBS data to the UE 100 between the PTP (PTP communication path) and the PTM (PTM communication path). The gNB 200 may perform duplication transmission of the same MBS data using both the PTP (PTP communication path) and the PTM (PTM communication path) to improve reliability.

A predetermined layer terminating the split is the MAC layer (HARQ), the RLC layer, the PDCP layer, or the SDAP layer. Although an example in which the predetermined layer terminating the split is the PDCP layer will be mainly described below, the predetermined layer may be the MAC layer (HARQ), the RLC layer, or the SDAP layer.

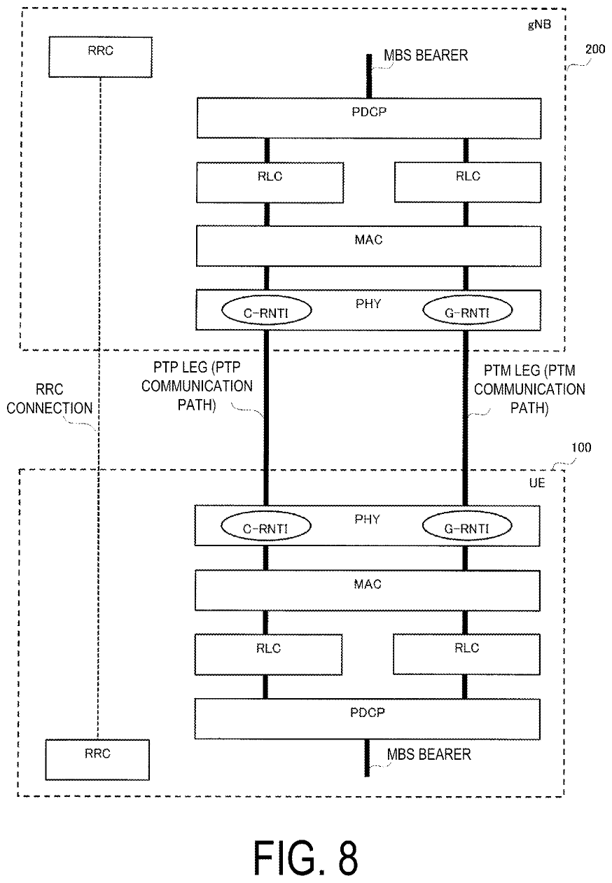

FIG. 8 is a diagram illustrating the split MBS bearer according to an embodiment. Hereinafter, the PTP communication path is referred to as a PTP leg, and the PTM communication path is referred to as a PTM leg. A functional unit corresponding to each layer is referred to as an entity.

As illustrated in FIG. 8, each of the PDCP entity of the gNB 200 and the PDCP entity of the UE 100 splits an MBS bearer, which is a bearer (data radio bearer) used for the MBS, into a PTP leg and a PTM leg. Note that the PDCP entity is provided for each bearer.

Each of the gNB 200 and the UE 100 includes two RLC entities provided per leg, one MAC entity, and one PHY entity. The PHY entity may be provided per leg. Note that, in a dual connectivity in which the UE 100 communicates with two gNBs 200, the UE 100 may include two MAC entities.

The PHY entity transmits and receives data of the PTP leg using a cell RNTI (cell radio network temporary identifier (C-RNTI)) that is allocated to the UE 100 on a one-to-one basis. The PHY entity transmits and receives data of the PTM leg using a group RNTI (group radio network temporary identifier (G-RNTI)) allocated to the MBS session on a one-to-one basis. The C-RNTI is different for each UE 100, but the G-RNTI is an RNTI common to a plurality of UEs 100 receiving one MBS session.

In order to perform PTM transmission of the MBS data (multicast or broadcast) from the gNB 200 to the UE 100 using a PTM leg, a split MBS bearer needs to be configured for the UE 100 from the gNB 200 and the PTM leg needs to be activated. In other words, even if a split MBS bearer is configured for the UE 100, when a PTM leg is in a deactivation state, the gNB 200 cannot perform the PTM transmission of the MBS data using the PTM leg.

In order for the gNB 200 and the UE 100 to perform PTP transmission of the MBS data (unicast) using a PTP leg, a split MBS bearer needs to be configured for the UE 100 from the gNB 200 and the PTP leg needs to be activated. In other words, even if a split MBS bearer is configured for the UE 100, when a PTP leg is in a deactivation state, the gNB 200 cannot perform the PTP transmission of the MBS data using the PTP leg.

When the PTM leg is in an activated state, the UE 100 monitors a physical downlink control channel (PDCCH) to which a G-RNTI associated with the MBS session is applied (i.e., performs blind decoding of the PDCCH using the G-RNTI). The UE 100 may monitor the PDCCH only at a scheduling occasion of the MBS session.

When the PTM leg is in a deactivated state, the UE 100 does not monitor a PDCCH to which a G-RNTI associated with the MBS session is applied (i.e., does not perform blind decoding of the PDCCH using the G-RNTI).

When the PTP leg is in an activated state, the UE 100 monitors a PDCCH to which a C-RNTI is applied. When discontinuous reception (DRX) in the PTP leg is configured, the UE 100 monitors a PDCCH for a configured OnDuration period. When a cell (frequency) associated with the MBS session is specified, the UE 100 may monitor a PDCCH for the cell even when the cell is deactivated.

When the PTP leg is in a deactivated state, the UE 100 may monitor a PDCCH to which a C-RNTI is applied in preparation for normal unicast downlink transmission of other than the MBS data. However, when a cell (frequency) associated with an MBS session is specified, the UE 100 may not monitor a PDCCH for the MBS session.

Note that it is assumed that the above-described split MBS bearer is configured by use of an RRC message (for example, an RRC Reconfiguration message) transmitted by the RRC entity of the gNB 200 to the RRC entity of the UE 100.

Activation and Deactivation of Leg

The activation and deactivation of a leg according to an embodiment is described.

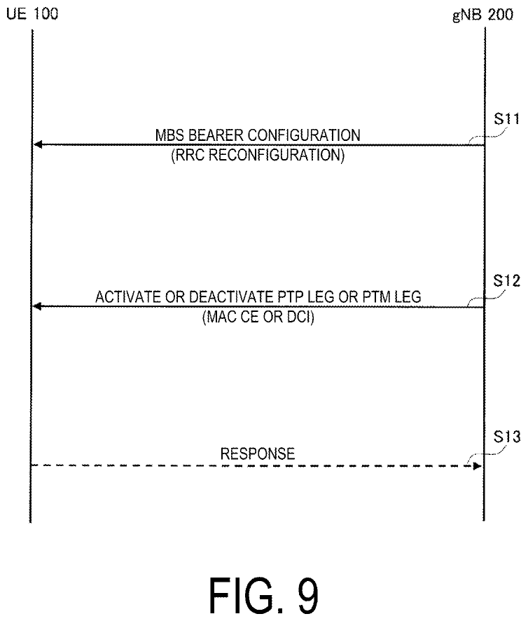

FIG. 9 is a diagram illustrating Operation Example 1 related to the activation and deactivation of a leg according to an embodiment.

As illustrated in FIG. 9, in step S11, the RRC entity of the gNB 200 transmits to the UE 100 an RRC message including a configuration of the split MBS bearer (split bearer) illustrated in FIG. 8. The RRC message may be an RRC Reconfiguration message, for example. The RRC entity of the UE 100 establishes a split MBS bearer based on the configuration included in the RRC message received from the gNB 200. In the following, although an example in which one split MBS bearer is established by the UE 100 is mainly described below, the UE 100 may establish a plurality of split MBS bearers depending on the configuration from the gNB 200.

The gNB 200, when configuring a bearer by use of the RRC message (RRC Reconfiguration message), may indicate an initial state of each leg (that is, activation or deactivation of each leg) to the UE 100 by use of the same message. The RRC entity of the gNB 200, when transmitting the RRC message including the bearer configuration of the split MBS bearer to the UE 100, includes the indication of the activation or deactivation of each leg together with the bearer configuration in the RRC message.

Such an RRC message may include an identifier of a leg (a PTP leg or a PTM leg) to be indicated and/or an identifier indicating any one of activation and deactivation. The RRC message may include an identifier (for example, a TMGI, a G-RNTI, a session identifier, a QoS flow identifier, or a bearer identifier) associated with the MBS session (split MBS bearer) to be indicated.

In step S12, the gNB 200 transmits to the UE 100 an indication of individually activating or deactivating the PTP leg and the PTM leg.

Here, the MAC entity of the gNB 200 may transmit a MAC control element (MAC CE) including the indication to the UE 100. The MAC entity of the UE 100 receives the MAC CE from gNB 200. The PHY entity of the gNB 200 may transmit downlink control information (DCI) including the indication to the UE 100. The PHY entity of the UE 100 receives the DCI from the gNB 200.

Such a MAC CE or DCI may include an identifier of a leg (a PTP leg or a PTM leg) to be indicated and/or an identifier indicating any one of activation and deactivation. The MAC CE or the DCI may include an identifier (for example, a TMGI, a G-RNTI, a session identifier, a QoS flow identifier, or a bearer identifier) associated with the MBS session (split MBS bearer) to be indicated.

Indicating the activation and deactivation of each leg by use of the MAC CE or the DCI allows more dynamic control compared with by use of the RRC message.

The UE 100, in response to receiving the indication of activating the PTP leg, starts data reception processing using the C-RNTI. The UE 100, in response to receiving the indication of activating the PTM leg, starts MBS data reception processing using the G-RNTI. On the other hand, the UE 100, in response to receiving the indication of deactivating the PTP leg, ends the data reception processing using the C-RNTI. The UE 100, in response to receiving the indication of deactivating the PTM leg, ends the MBS data reception processing using the G-RNTI.

In step S12, the gNB 200 may transmit an indication of activating or deactivating the PTP leg to the UE 100 via the PTM leg in the activated state (PTM transmission). This can collectively activate or deactivate the PTP legs of a plurality of UEs 100 via the PTM.

The gNB 200 may transmit an indication of deactivating the PTM leg to the UE 100 via the PTM leg in the activated state (PTM transmission). This can collectively deactivate the PTM legs of a plurality of UEs 100 via the PTM.

In step S12, the gNB 200 may transmit an indication of activating or deactivating the PTM leg to the UE 100 via the PTP leg in the activated state (PTP transmission). This can individually activate or deactivate the PTM leg for each UE 100.

The gNB 200 may transmit an indication of deactivating the PTP leg to the UE 100 via the PTP leg in the activated state (PTP transmission). This can individually deactivate the PTP leg for each UE 100.

In step S13, the UE 100, in response to receiving the indication of activating the PTP leg and/or the PTM leg from the gNB 200 in step S12, may transmit to the gNB 200 a response to the received indication. This response may be transmitted from the MAC entity of the UE 100 to the gNB 200 via the PTP leg, for example. The UE 100, after transmitting the response, may start a data reception operation on the activated leg.

The gNB 200, in response to receiving the response from the UE 100, transmits data via the activated leg. In other words, the gNB 200, after receiving the response, starts a data transmission operation on the leg.

Note that the UE 100, in response to receiving the indication of deactivating the PTP leg and/or the PTM leg from the gNB 200 in step S12, may transmit to the gNB 200 a response to the received indication.

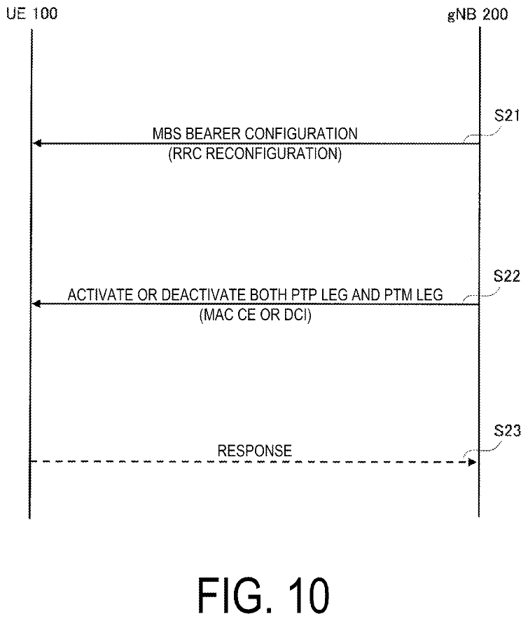

FIG. 10 is a diagram illustrating Operation Example 2 related to the activation and deactivation of a leg according to an embodiment. The basic operation of Operation Example 2 is the same as and/or similar to that of Operation Example 1, and thus, differences from Operation Example 1 are mainly described here. Note that Operation Example 2 can be used together with Operation Example 1.

In Operation Example 2, the gNB 200 transmits to the UE 100 an indication of activating or deactivating both the PTP leg and the PTM leg. For example, the MAC entity of the gNB 200 includes both a PTP leg control indication and a PTM leg control indication in the MAC CE indicating of activating or deactivating the leg.

As illustrated in FIG. 10, in step S21, the RRC entity of the gNB 200 transmits to the UE 100 an RRC message including the configuration of the split MBS bearer (split bearer) illustrated in FIG. 8. As described above, the RRC message may include information configuring an initial state of each leg. The information configuring the initial state of each leg may be information the same as and/or similar to an indication included in the MAC CE or DCI described below.

In step 522, the gNB 200 transmits to the UE 100 an indication of activating or deactivating both the PTP leg and the PTM leg. As described above, the MAC CE or the DCI includes the indication.

Here, the MAC CE or the DCI includes an indication value of activation (for example, “1”) of both the PTP leg and the PTM leg, or deactivation (for example, “0”) of both the PTP leg and the PTM leg. The activation of both the PTP leg and the PTM leg may be activation of the split MBS bearer or activation of the duplication transmission using two legs. The deactivation of both the PTP leg and the PTM leg may be deactivation of the split MBS bearer or deactivation of the duplication transmission using two legs.

The MAC CE or the DCI may include an identifier (for example, a TMGI, a G-RNTI, a session identifier, a QoS flow identifier, or a bearer identifier) associated with the MBS session (split MBS bearer) to be indicated. The MAC CE or the DCI may include an indication of activation or deactivation for each such identifier.

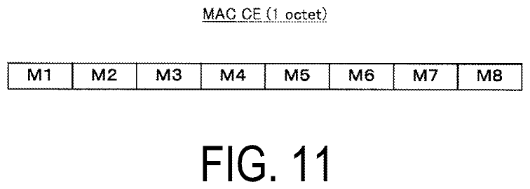

FIG. 11 is a diagram illustrating an example of a MAC CE (one octet) storing an indication value for each bearer identifier (or logical channel identifier) according to an embodiment. As illustrated in FIG. 11, in the MAC CE, M1 to M8 correspond to bearers #1 to #8 (or logical channels #1 to #8). Each of fields M1 to M8 is one bit, and an indication value of activation (for example, “1”) or deactivation (for example, “0”) is stored in each field.

Step S23 is the same as and/or similar to that in Operation Example 1. The UE 100 may transmit a response to the gNB 200.

When both the PTP leg and the PTM leg are activated, the PDCP entity of the UE 100 may perform a duplicate packet discarding process on two identical MBS packets transmitted through the duplication transmission.

When the PTP leg is deactivated, the RRC entity of the UE 100 may transmit to the gNB 200 a message (RAI: release assistance information/preference) for prompting the gNB 200 to release the RRC connection. The UE 100 may be permitted to transmit the RAI even when dynamic switching between the PTP leg and the PTM leg is being configured.

Operation of Switching Between PTP Transmission and PTM Transmission

An operation of switching between PTP transmission and PTM transmission according to an embodiment is described.

Assuming the use of the split MBS bearer, the PTP transmission may be a scheme of transmitting the MBS data from the gNB 200 to the UE 100 by using the PTP leg (PTP communication path). The PTM transmission may be a scheme of transmitting the MBS data from the gNB 200 to the UE 100 by using the PTM leg (PTM communication path).

The use of the split MBS bearer need not be assumed. The PTP transmission may be a scheme of transmitting the MBS data from the gNB 200 to the UE 100 by using a PTP bearer (PTP communication path) as a first data radio bearer for PTP. The PTM transmission may be a scheme of transmitting the MBS data from the gNB 200 to the UE 100 by using a PTM bearer (PTM communication path) as a second data radio bearer for PTM.

The operation of switching between the PTP transmission and the PTM transmission is an operation of ending an MBS data transmission through one of the PTP transmission and the PTM transmission, while simultaneously starting MBS data transmission through the other transmission scheme. In such a switching operation, some of the MBS data (MBS packets) transmitted from the gNB 200 to the UE 100 may go missing. When such a packet loss occurs, the retransmission in the PDCP layer (or RLC layer) is preferably performed in order to increase reliability of the communication.

In the UE 100 according to an embodiment, the receiver 110 receives the MBS data transmitted from the gNB 200 through a transmission scheme either of the Point-To-Point (PTP) transmission and the Point-To-Multipoint (PTM) transmission. In response to switching the transmission scheme between the PTP transmission and the PTM transmission, the controller 130 of the UE 100 triggers transmission of a status report indicating a reception status of the MBS data in a predetermined layer of the UE 100. The transmitter 120 of the UE 100 transmits the status report to the gNB 200.

This allows the gNB 200 to recognize the reception status of the MBS data of the UE 100 regarding the switching between the PTP transmission and the PTM transmission. Even if an MBS packet goes missing when switching between the PTP transmission and the PTM transmission, the gNB 200 can therefore easily identify the lost MBS packet. Accordingly, when a packet loss of an MBS packet occurs, reliability of the communication can be improved since the retransmission in the PDCP layer (or the RLC layer) is possible.

An example is described below in which the predetermined layer is the PDCP layer and the status report transmitted from the UE 100 to the gNB 200 is a PDCP status report. Note that the predetermined layer may also be the RLC layer. The status report transmitted from the UE 100 to the gNB 200 may be an RLC status report (RLC Status PDU).

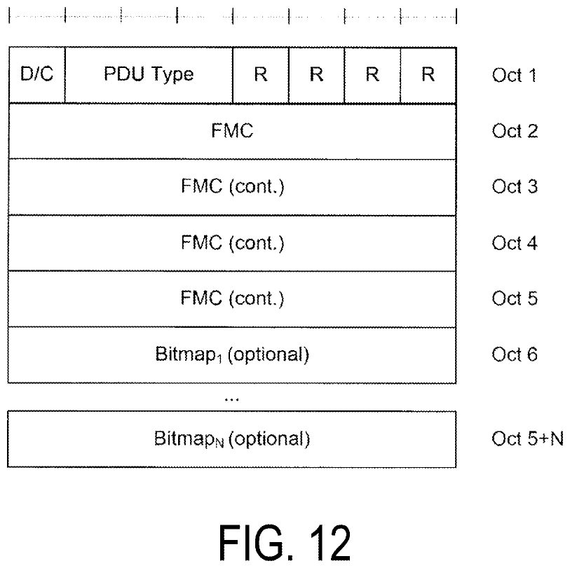

FIG. 12 is a diagram illustrating a configuration example of the PDCP status report according to an embodiment.

As illustrated in FIG. 12, the PDCP status report includes, as main components thereof, a “D/C” field having a 1-bit length, a “PDU Type” field having a 3-bit length, an “FMC (First Missing COUNT)” field having a 32-bit length, and a “Bitmap” field having a variable bit length.

The “D/C” field is a field indicating whether this PDCP PDU is a PDCP Data PDU or a PDCP Control PDU. The PDCP status report corresponds to a PDCP Control PDU.

The “PDU Type” field is a field indicating which of a “PDCP status report”, “Interspersed ROHC feedback”, and “EHC feedback” this PDCP Control PDU is.

The “FMC (First Missing COUNT)” field is a field indicating a count value (COUNT) of a first missing PDCP SDU in a reordering window. Note that the count value (COUNT) includes an HFN (Hyper Frame Number) and a PDCP sequence number.

The “Bitmap” field is a field indicating a missing PDCP SDU and a PDCP SDU successfully received at a PDCP entity on the reception side. Specifically, the “Bitmap” field indicates a reception status of the PDCP SDU from the FMC onwards as “0” (missing) or “1” (correctly received).

(1) Operation of Switching from PTM Transmission to PTP Transmission

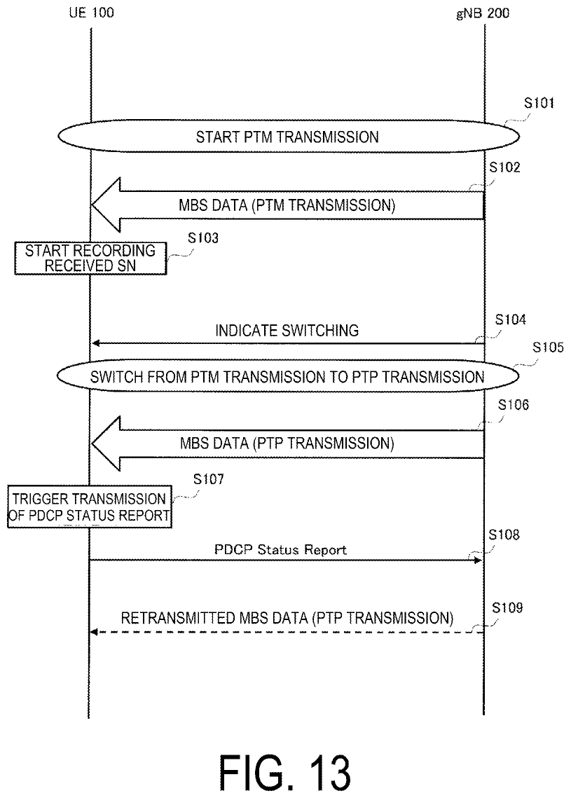

An operation of switching from PTM transmission to PTP transmission according to an embodiment is described. FIG. 13 is a diagram illustrating the operation of switching from the PTM transmission to the PTP transmission according to an embodiment. In the following description, it is assumed that the gNB 200 has established an MBS connection with the 5GC 20 for shared MBS data delivery (shared MBS traffic delivery) illustrated in FIG. 7.

As illustrated in FIG. 13, in step S101, the gNB 200 starts PTM transmission of MBS data. Specifically, the gNB 200 starts multicast or broadcast transmission of MBS data belonging to a certain MBS session.

In step S102, the gNB 200 transmits the MBS data belonging to the certain MBS session through PTM. The UE 100 receives the MBS data.

In step S103, the PDCP entity of the UE 100 may record each of a sequence number of MBS data successfully received and a sequence number of MBS data not successfully received among the MBS data (PDCP SDU) transmitted through PTM to generate a PDCP status report.

In step S104, the gNB 200 transmits, to the UE 100, an indication of switching from the PTM transmission to the PTP transmission. The indication may be a deactivation indication of the PTM leg and/or an activation indication of the PTP leg. The indication may be an indication of changing from the PTM bearer to the PTP bearer by use of an RRC message (for example, RRC Reconfiguration message). The indication may include a transmission indication or transmission configuration of the PDCP status report. Note that the UE 100 may voluntarily trigger (step S107) and transmit (step S108) the PDCP status report even without the transmission indication or transmission configuration of the PDCP status report from the gNB 200.

In step S105, the gNB 200 and the UE 100 perform a process of switching from the PTM transmission to the PTP transmission. Specifically, the gNB 200 and the UE 100 end the PTM transmission of the MBS data belonging to the certain MBS session and start the PTP transmission of the MBS data belonging to the MBS session.

In step S106, the gNB 200 transmits the MBS data belonging to the MBS session through PTP. The UE 100 receives the MBS data.

In the process of switching from the PTM transmission to the PTP transmission, the UE 100 can possibly fail to receive the last MBS data (PDCP SDU) transmitted through PTM. In this case, the PDCP entity of the UE 100 records the sequence number of the MBS data (PDCP SDU) not successfully received among the MBS data (PDCP SDU) transmitted through PTM.

In the process of switching from the PTM transmission to the PTP transmission, the UE 100 can possibly fail to receive the first MBS data (PDCP SDU) transmitted through PTP. In this case, the PDCP entity of the UE 100 records a sequence number of the MBS data (PDCP SDU) not successfully received among the MBS data (PDCP SDU) transmitted through PTP.

In step S107, the PDCP entity of the UE 100 triggers transmission of the PDCP status report. Specifically, the PDCP entity of the UE 100 generates a PDCP status report as illustrated in FIG. 12 and passes the PDCP status report to a lower layer.

Here, the PDCP entity of the UE 100 may trigger the transmission of the PDCP status report when receiving the indication in step S104, or trigger the transmission of the PDCP status report when performing the process of switching in step S105.

The PDCP entity of the UE 100 may trigger the transmission of the PDCP status report a certain period of time after receiving the indication in step S104, or may trigger the transmission of the PDCP status report a certain period of time after performing the process of switching in step S105. Such a certain period of time (a timer value) may be configured by the gNB 200 for the UE 100.

A condition for the UE 100 to trigger the transmission of the PDCP status report may include a condition that the sequence number of the MBS data received last through PTM is discontinuous with the sequence number of the MBS data received first through PTP. The PDCP entity of the UE 100 triggers the transmission of the PDCP status report only when detecting such a discontinuity. The condition for the UE 100 to trigger the transmission of the PDCP status report may include detecting a missing (sequence number discontinuity) in the MBS data transmitted through PTM.

In step S108, the lower layers of the UE 100 (RLC entity, MAC entity, and PHY entity) transmit the PDCP status report to the gNB 200. The gNB 200 receives the PDCP status report.

In step S109, the gNB 200 retransmits the missing MBS data to the UE 100 in PTP, based on lost packet information (FMC and Bitmap) included in the PDCP status report. The UE 100 receives the MBS data retransmitted through PTP.

In this way, in switching from the PTM transmission to the PTP transmission, even if the MBS data is missing in the UE 100, the missing MBS data can be identified based on the PDCP status report, and the missing MBS data can be complemented by the retransmission in the PDCP layer.

(2) Operation of Switching from PTP Transmission to PTM Transmission

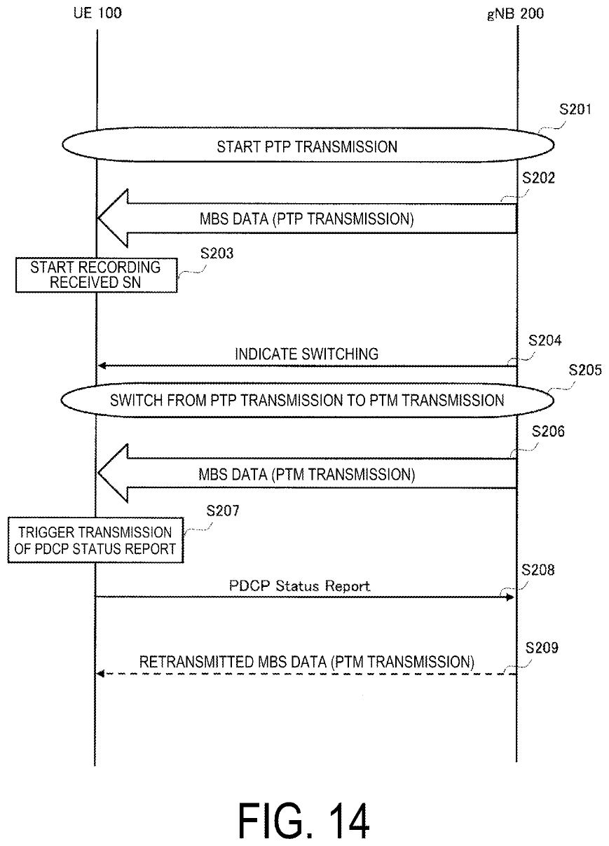

An operation of switching from PTP transmission to PTM transmission according to an embodiment is described. FIG. 14 is a diagram illustrating the operation of switching from the PTP transmission to the PTM transmission according to an embodiment.

As illustrated in FIG. 14, in step S201, the gNB 200 starts PTP transmission of MBS data. Specifically, the gNB 200 starts unicast transmission of MBS data belonging to a certain MBS session.

In step S202, the gNB 200 transmits the MBS data belonging to the certain MBS session through PTM. The UE 100 receives the MBS data.

In step S203, the PDCP entity of the UE 100 may record a sequence number of MBS data successfully received and a sequence number of MBS data not successfully received among the MBS data (PDCP SDU) transmitted through PTP to generate a PDCP status report.

In step S204, the gNB 200 transmits, to the UE 100, an indication of switching from the PTP transmission to the PTM transmission. The indication may be a deactivation indication of a PTP leg and/or an activation indication of a PTM leg. The indication may be an indication of changing from a PTP bearer to a PTM bearer by use of an RRC message (for example, RRC Reconfiguration message). The indication may include a transmission indication or transmission configuration of the PDCP status report. Note that the UE 100 may voluntarily trigger (step S207) and transmit (step S208) the PDCP status report even without the transmission indication or transmission configuration of the PDCP status report from the gNB 200.

In step S205, the gNB 200 and the UE 100 perform a process of switching from the PTP transmission to the PTM transmission. Specifically, the gNB 200 and the UE 100 end the PTP transmission of the MBS data belonging to the certain MBS session and start the PTM transmission of the MBS data belonging to the certain MBS session.

In step S206, the gNB 200 transmits the MBS data belonging to the MBS session through PTM. The UE 100 receives the MBS data.

In the process of switching from the PTP transmission to the PTM transmission, the UE 100 can possibly fail to receive the last MBS data (PDCP SDU) transmitted through PTP. In this case, the PDCP entity of the UE 100 records a sequence number of the MBS data (PDCP SDU) not successfully received among the MBS data (PDCP SDU) transmitted through PTP.

In the process of switching from the PTP transmission to the PTM transmission, the UE 100 can possibly fail to receive the first MBS data (PDCP SDU) transmitted through PTM. In this case, the PDCP entity of the UE 100 records a sequence number of the MBS data (PDCP SDU) not successfully received of the MBS data (PDCP SDU) transmitted through PTM.

In step S207, the PDCP entity of the UE 100 triggers transmission of the PDCP status report. Specifically, the PDCP entity of the UE 100 generates a PDCP status report as illustrated in FIG. 12 and passes the PDCP status report to a lower layer.

Here, the PDCP entity of the UE 100 may trigger the transmission of the PDCP status report when receiving the indication in step S204, or may trigger the transmission of the PDCP status report when performing the process of switching in step S205.

The PDCP entity of the UE 100 may trigger the transmission of the PDCP status report a certain period of time after receiving the indication in step S204, or may trigger the transmission of the PDCP status report a certain period of time after performing the process of switching in step S205. Such a certain period of time (a timer value) may be configured by the gNB 200 for the UE 100.

A condition for the UE 100 to trigger the transmission of the PDCP status report may include a condition that the sequence number of the MBS data received last through PTP is discontinuous with the sequence number of the MBS data received first through PTM. The PDCP entity of the UE 100 triggers the transmission of the PDCP status report only when detecting such a discontinuity. The condition for the UE 100 to trigger the transmission of the PDCP status report may include detecting a missing (sequence number discontinuity) in the MBS data transmitted through PTP.

In step S208, the lower layers of the UE 100 (RLC entity, MAC entity, and PHY entity) transmit the PDCP status report to the gNB 200. The gNB 200 receives the PDCP status report.

In step S209, the gNB 200 retransmits the missing MBS data to the UE 100 through PTM, based on lost packet information (FMC and Bitmap) included in the PDCP status report. The UE 100 receives the MBS data retransmitted through PTM.

In this way, in switching from the PTP transmission to the PTM transmission, even if the MBS data is missing in the UE 100, the missing MBS data can be identified based on the PDCP status report, and the missing MBS data can be complemented by the retransmission in the PDCP layer.

(3) Variation of Operation of Switching from PTP Transmission to PTM Transmission

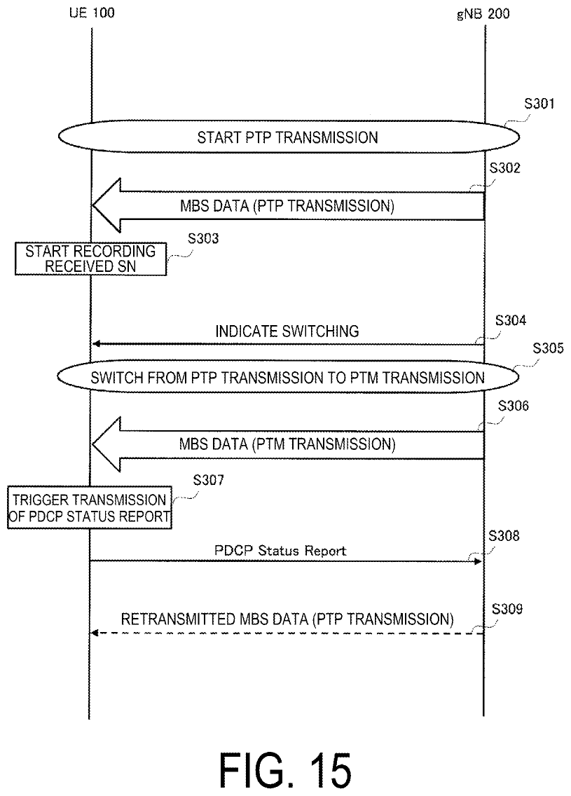

A variation of the operation of switching from the PTP transmission to the PTM transmission according to an embodiment is described. FIG. 15 is a diagram illustrating the variation of the operation of switching from the PTP transmission to the PTM transmission according to an embodiment.

As illustrated in FIG. 15, operations in steps S301 to S308 are the same as, and/or similar to, those in FIG. 14. Note that, in steps S304 and S305, the gNB 200 and the UE 100 maintain the active state without deactivating the PTP communication path (PTP leg).

In step S309, the gNB 200 retransmits the missing MBS data to the UE 100 through PTP, based on the lost packet information (FMC and Bitmap) included in the PDCP status report. The UE 100 receives the MBS data retransmitted through PTP.

In this way, the gNB 200 and the UE 100 perform the MBS data retransmission process through PTP while performing the MBS data initial transmission process through PTM. As a result, the MBS data can be retransmitted through PTP only to the UE 100 in which missing MBS data has occurred, allowing an efficient retransmission process to be realized. Note that, when the missing MBS data is complemented by the retransmission, the UE 100 may voluntarily stop the reception process through PTP.

### Other Embodiments

In the above-described embodiments, an example is described in which the PTP communication path is configured using the PTP leg and the PTM communication path is configured using the PTM leg by using the split MBS bearer. However, the PTP communication path may be configured using a first radio bearer for PTP and the PTM communication path may be configured using a second radio bearer for PTM, by using two radio bearers (data radio bearers).

In the above-described embodiments, an example is described in which the predetermined layer is the PDCP layer and the status report transmitted from the UE 100 to the gNB 200 is the PDCP status report. However, the PDCP entity in the above-described embodiments may be interpreted as an RLC entity, and the PDCP status report may be interpreted as an RLC status report (RLC Status PDU).

The operation flows described above can be separately and independently implemented, and also be implemented in combination of two or more of the operation flows. For example, some steps of one operation flow may be added to another operation flow, or some steps of one operation flow may be replaced with some steps of another operation flow.

In the embodiment described above, an example in which the base station is an NR base station (i.e., a gNB) is described; however, the base station may be an LTE base station (i.e., an eNB). The base station may be a relay node such as an integrated access and backhaul (IAB) node. The base station may be a distributed unit (DU) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

### REFERENCE SIGNS

10: NG-RAN (5G RAN)
20: 5GC (5G CN)
100: UE
110: Receiver
120: Transmitter
130: Controller
200: gNB
210: Transmitter
220: Receiver
230: Controller
240: Backhaul communicator

1. A communication control method performed by a user equipment in a mobile communication system for providing a multicast broadcast service (MBS), the communication control method comprising:
receiving an RRC message transmitted from a base station;
receiving MBS data transmitted from the base station through a transmission scheme using either Point-To-Point (PTP) transmission or Point-To-Multipoint (PTM) transmission;
triggering transmission of a status report indicating a reception status of the MBS data in a predetermined layer of the user equipment based on an instruction included in the RRC message; and
transmitting the status report to the base station, wherein
the RRC message included a bearer identifier associated with an MBS bearer.

2. The communication control method according to claim 1, wherein
the predetermined layer is a Packet Data Convergence Protocol (PDCP) layer, and
the status report is a PDCP status report.

3. The communication control method according to claim 1, wherein
the RRC message is an RRC Reconfiguration message.

4. A user equipment used in a mobile communication system for providing a multicast broadcast service (MBS), the user equipment comprising:
a receiver configured to receive an RRC message transmitted from a base station and receive MBS data transmitted from the base station through a transmission scheme either of Point-To-Point (PTP) transmission or Point-To-Multipoint (PTM) transmission;
a controller configured to trigger transmission of a status report indicating a reception status of the MBS data in a predetermined layer of the user equipment based on an instruction included in the RRC message; and
a transmitter configured to transmit the status report to the base station, wherein
the RRC message includes a bearer identifier associated with an MBS bearer.
